(19) United States
(12) Patent Application Publication
(10) Pub. No.: US 2006/0098849 A1
(43) Pub. Date: May 11, 2006

(54) System and method for reducing healthcare fraud using biometric technology

(75) Inventor: Gary Woodward, Holland, TX (US)

Correspondence Address: EPSTEIN DRANGEL BAZERMAN & JAMES, LLP, 60 EAST 42ND STREET, SUITE 820, NEW YORK, NY, 10165, US

(73) Assignee: Sagem Morpho, Inc.

(21) Appl. No.: 11/269,476

(22) Filed: Nov. 7, 2005

Related U.S. Application Data
(60) Provisional application No. 60/626,631, filed on Nov. 10, 2004.

(51) Int. Cl. G06K 9/00

(52) U.S. Cl. 382/124; 340/5.83

(57) ABSTRACT

An integrated intelligent finger scanner is used for reducing fraud in a healthcare program intended to exclusively benefit eligible individuals. The scanner has a finger scanner for acquiring the image of a finger, and data processing means for encoding the acquired image into biometric candidate data and for comparing the biometric candidate data with other data. The method includes: (a) receiving, from a service seeker, memory means containing stored information comprising biometric reference data of an eligible individual; (b) reading, with a POS terminal having a memory means reader, the stored biometric reference data of the eligible individual from the memory means; (c) transmitting the read biometric reference data from the POS terminal to the integrated intelligent finger scanner operably connected to the POS terminal; (d) scanning, with the integrated intelligent finger scanner, a finger of the service seeker, so as to produce finger scan data; (e) processing the produced finger scan data to create biometric candidate data; (f) comparing the read biometric reference data with the created biometric candidate data; (g) ascertaining the degree of correspondence between the read biometric reference data and the created biometric candidate data; and (h) deciding whether the service seeker is the eligible individual based upon the degree of correspondence between the read biometric reference data and the created biometric candidate data.

### CROSS-REFERENCE TO RELATED APPLICATIONS

This application claims priority of U.S. Provisional Application Ser. No. 60/626,631, filed 10 Nov. 2004.

### STATEMENT REGARDING FEDERALLY SPONSORED RESEARCH OR DEVELOPMENT

Not Applicable

REFERENCE TO A “SEQUENCE LISTING”, A TABLE, OR A COMPUTER PROGRAM LISTING APPENDIX SUBMITTED ON COMPACT DISC

Not Applicable

### BACKGROUND OF THE INVENTION

1. Field of the Invention

The present invention relates to fraud in healthcare programs and more particularly to a system and method for reducing fraud in healthcare utilizing biometric technology.

2. Description of Prior Art Including Information Disclosed Under 37 CFR 1.97 and 1.98

Healthcare providers obtain reimbursement for their services to eligible individuals from a variety of government sponsored programs, such a Medicare and Medicaid, and from a plurality of private insurance carriers, such as Blue Cross and Oxford. Persons seeking care from the healthcare profession commonly identify themselves as being eligible for reimbursement for the services rendered by presenting a membership card issued by the reimbursing agency.

However, such membership cards are often lost or stolen and are easily falsified. Since the healthcare provider has no way of verifying whether the person presenting the membership card is actually the individual that is eligible for reimbursement, services are provided based upon the presentation of the membership card, with the understanding that reimbursement for the services rendered will be obtained from the reimbursing agency at a later time.

If it turns out that the person to whom the services were provided did not possess an authentic membership card, or is not the eligible individual identified on the card, but instead is impersonating that individual, a fraud occurs. If the healthcare provider has been reimbursed, the reimbursing agency has been defrauded because it has paid for services for which it is not required to pay. That type of fraud is so prevalent that government programs pay out millions of dollars that they are not legally obligated to pay. On the other hand, if the fraud is discovered and the reimbursing agency refuses to reimburse the healthcare provider for the services rendered, the healthcare provider has been defrauded. In either case, there is a great need for a system that is capable of reducing healthcare fraud.

The present invention relates to a system and method for reducing healthcare fraud that utilizes biometric techniques. Applicant is not aware of any other system which utilizes such technology or which provides the advantages of the present invention.

Applicant is are of U.S. Pat. No. 6,873,960 to Wood, entitled “Method for Reducing Fraud in Healthcare Programs Using a Smart Card” which briefly mentions the possibility of biometrics. However, the methods described by Wood and others require a personal computer to operate. The disadvantage of using a computer for this purpose is that if the computer is dedicated to this task, it adds clutter and expense to the office of the healthcare provider. On the other hand, if the computer is used for other purposes, operating the computer for fraud detection introduces a drag on computer resources and increases the likelihood that this application will interrupt or interfere with other work being performed.

It is, therefore, a prime object of the present invention to provide a system and method for reducing healthcare fraud using biometric technology.

It is another object of the present invention to provide a system and method for reducing healthcare fraud using biometric technology that permits ready biometric identification and authentication.

It is another object of the present invention to provide a system and method for reducing healthcare fraud using biometric technology that achieves biometric identification and authentication, quickly and inexpensively, and without the need for external dedicated or non-dedicated personal computers.

It is another object of the invention to provide a system and method for reducing healthcare fraud using biometric technology that employs a POS device that is capable of running software resident therein and operating in standalone mode in the healthcare provider's office to create a file which captures data associated with the services which are being rendered to the patient on a particular occasion.

It is another object of the present invention to provide a system and method for reducing healthcare fraud using biometric technology that creates a file of data reflecting each of the services rendered to the patient.

It is another object of the present invention to provide a system and method for reducing healthcare fraud using biometric technology that permits the data files reflecting the services rendered to patients to be periodically uploaded in batch submission, e.g. once daily, to a host monitoring server which is designed for the specific purpose of comparing data received from providers' POS devices to subsequent claim and billing information and to historical claim and billing information for the specific purpose of identifying and investigating anomalies which would a indicate fraud and/or abuse of the healthcare services reimbursement system.

### BRIEF SUMMARY OF THE INVENTION

Healthcare services fraud may be reduced by the system of the present invention, by authenticating the identity of the patient seeking treatment covered by the program or plan of a reimbursing agency. Prior to the commencement of any treatment or series of treatments, the system of the present invention ascertains that the service seeker is in fact the eligible individual identified on the presented membership card by having the patient “check in” and “check out” at the beginning and end of each treatment session. That purpose is furthered by creating a file which discretely associates each treatment session with the authenticated identity of the patient, as well as the identity of the service provider and the exact nature of the treatment(s) provided during the session. All of the foregoing information is stored in a single file suitable for asynchronous data transmission, such as may be scheduled to occur periodically, e.g. daily. Accordingly, the invention permits ready biometric identification and authentication, performed quickly, inexpensively, and without the need for bulky stand-alone personal computers.

More specifically, in accordance with one aspect of the present invention, a method of using an integrated intelligent finger scanner for reducing fraud in a healthcare services reimbursement program intended to exclusively benefit eligible individuals is provided. The intelligent integrated finger scanner includes a finger scanner for acquiring the image of a finger. It also includes data processing means for encoding the image of a finger into biometric candidate data and for comparing that biometric candidate data with other data.

The method begins by receiving, from a service seeker presenting him or herself for healthcare services, a memory means which contains stored information comprising biometric reference data of an eligible individual. A POS terminal having a memory means reader, reads the stored biometric reference data of the eligible individual from the memory means. The read biometric reference data is transferred to the integrated intelligent finger scanner that is operably connected to the POS terminal. The integrated intelligent finger scanner scans a finger of the service seeker, so as to produce finger scan data. The produced finger scan data is processed to create biometric candidate data. The integrated intelligent finger scanner compares the read biometric reference data with the created biometric candidate data. The degree of correspondence between the read biometric reference data and the created biometric candidate data is ascertained. Based upon the degree of correspondence between the read biometric reference data and the created biometric candidate data, a decision is made as to whether the service seeker is the eligible individual.

Preferably, the information stored in the memory means also includes identifying indicia for the eligible individual. That may be the name, social security number, healthcare account number, unique identifying number for memory means, an identification of the primary care network (PCN), the date of birth, sex or the like. Additionally, or alternatively, the stored information also includes fingerprint minutiae.

The created biometric candidate data preferably includes fingerprint minutiae.

The memory means may be a smartcard. In that instance, the memory means reader includes a smartcard reader.

Alternatively, the memory means may be or include an RFID tag and the memory means reader may contain an RFID tag reader.

Deciding whether the service seeker is an eligible individual may include generating an audit flag associated with the identifying indicia, the stored biometric data or the candidate biometric data.

The method may include entering data into the POS terminal using data entry means. The data entry means may take the form of a keyboard.

The present invention may include the step of forwarding, from the POS terminal to a host server, data including a Provider Identifier (PI) number, a POS terminal identifier, a unique memory means identifier, information relating to the type of transaction. That data may also include the result of the step of deciding whether the service seeker is the eligible individual.

The method may also include step of storing the data. The stored data may include a Provider Identifier (PI) number, a POS terminal identifier, a unique memory means identifier, and/or information relating to the type of transaction, the result of the step of deciding whether the service seeker is the eligible individual, the name, date of birth, sex, social security number, or healthcare account number of the eligible individual, a unique identifying number for memory means, or an identification of the primary care network (PCN).

### BRIEF DESCRIPTION OF THE SEVERAL VIEWS OF DRAWINGS

To these and to such other objects that may hereinafter appear, the present invention relates to a system and method for reducing healthcare fraud using biometric technology as described in detail in the following specification and recited in the annexed claims, taken together with the accompanying drawings, in which like numerals refer to like parts and in which:

FIG. 1 is a block diagram schematically illustrating the components of the apparatus used to perform the method of the present invention;

FIG. 2 is a flowchart illustrating the steps of the method of the present invention;

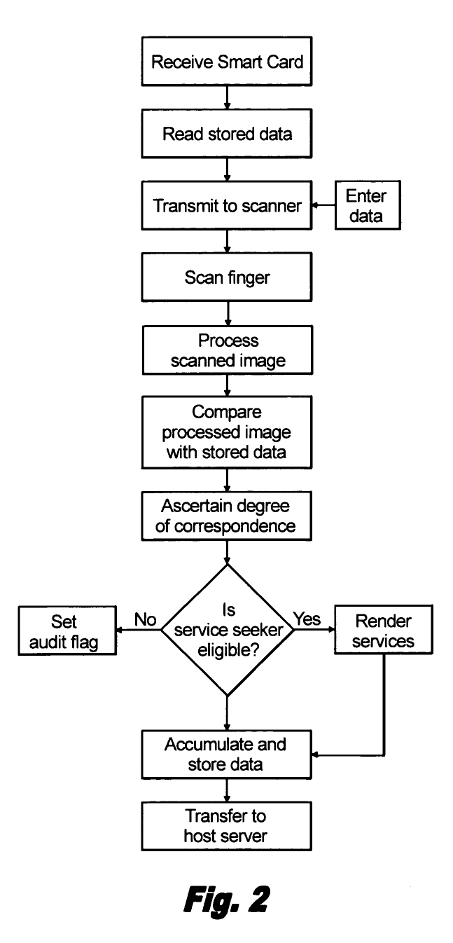

FIG. 3 is a flowchart showing the steps followed by the provider when using the method of the present invention.

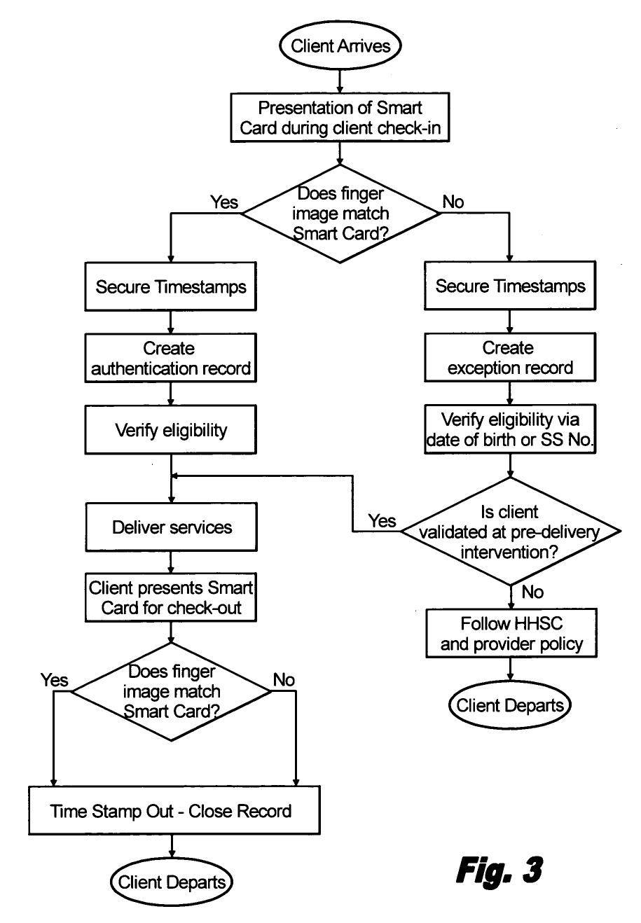

### DETAILED DESCRIPTION OF THE INVENTION

In the presently preferred embodiment, the system and method are implemented using two major components: a point-of-sale (POS) terminal, generally designated A, and a fingerprint scanner/processor, generally designated B. Terminal A is linked to scanner/processor B via an electronic interface.

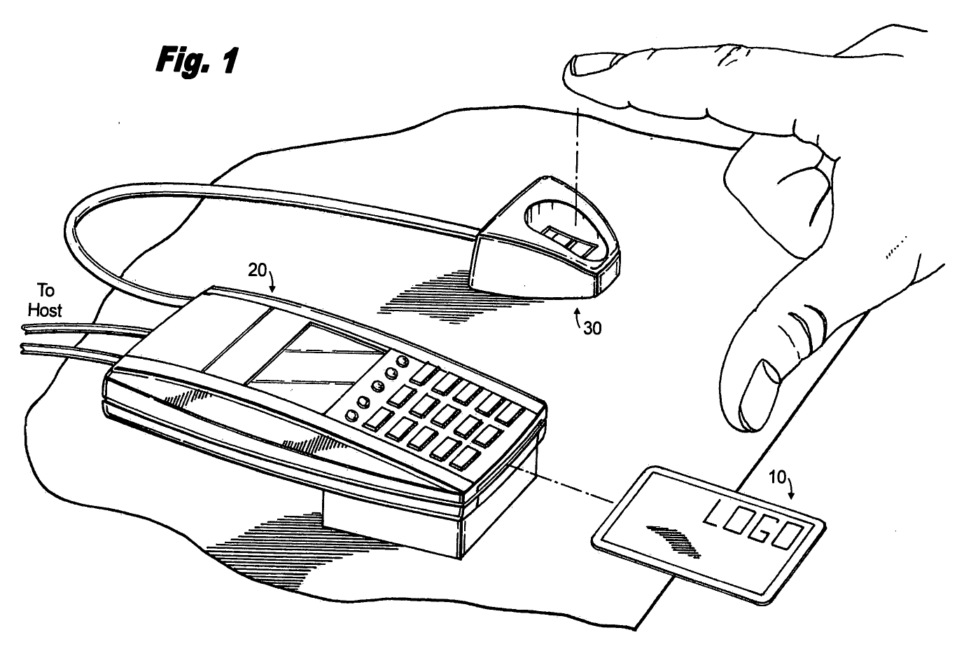

Referring to FIG. 1, point-of-sale (POS) terminal A includes an integrated non-volatile memory means reader, which for many applications may take the form of a smartcard reader. One commercially available POS terminal that may be utilized is the “Omni 3750” made by Verifone, Inc. of Santa Clara, Calif. That terminal also includes data processing means. The Omni 3750 will be used in the following description for illustrative purposes. However, it should understood that other comparable POS terminals with integrated non-volatile memory means (e.g. Smartcard) readers and data processing means might also be used.

POS terminal A is operably connected to the integrated intelligent fingerprint scanner/processor B, by a suitable connector, e.g. an IEEE RS-232 interface. If desired, the interface may also include additional electronic communication capability, e.g. an Ethernet or telephone or other modem, thereby permitting easy connection to server computer(s) and/or other devices.

For data input, POS terminal A includes a reader for the non-volatile memory means, such as a magnetic strip, RFID tag, memory chip, Smartcard, etc. Although the term “smartcard” is used herein to refer to the memory means, it should be understood that a smartcard is only an illustrative example of a usable memory means, and that term is used herein in a non-limiting sense.

The smartcard reader reads smartcards 10, which may be EMV or AMTEL AT88SC1616C smartcards or the like. The typical encoding of such smartcards is described elsewhere herein. The specifications for those smartcards are available from the respective manufacturers and are hereby incorporated by reference.

Preferably, the terminal also has additional data entry means. Those data entry means may take the form of a keypad.

For data processing, the POS terminal A includes an application-specific integrated circuit (ASIC) which permits the execution of appropriate programs. An example of such an appropriate program might be one which would comprise functionality such as would allow a service seeker to “check in” and “check out” of the facility, and permit codes for services rendered to be associated with the file of the service seeker who checks in, and perhaps also checks out.

The integrated fingerprint scanner B is an “intelligent” unit, such as the Morpho Smart Optical (MSO) available from Sagem-Morpho, Inc. of Tacoma, Wash., USA. That unit includes scanner means, capable of scanning the finger of an individual, and data processing means for encoding finger scan data, e.g. into “minutiae”. Minutiae is a term of art used to describe fingerprint ridges and valleys characterized by discontinuities and irregularities. (See page 51 of the book “Biometrics: Identity Verification in a Networked World”, published 2002 by Wiley Computer Publishing, the contents of which are incorporated by reference.) Scanner B is also capable of making a comparison between the encoded finger scan data and biometric reference data read from the smartcard. Scanner B may accomplish its scanning through an imaging window, or platen, upon which a human digit is pressed so as to have its fingerprint read.

Scanner B also has software implementing a suitable finger scan date encoding means which converts the optical fingerprint image into a digital image file. It then encodes the digital image file biometric data into the form of “minutiae” such that it represents a set of extracted characteristics of the scanned finger's features.

In scanner B, the contemporaneously-created biometric data, which in this example is fingerprint minutiae data, is compared with stored biometric reference data obtained by the POS terminal from the non-volatile memory means, in this case smartcard 10. The data read from the smart card is preferably already in the form of fingerprint minutiae data. The comparison is accomplished automatically, when a service seeker presents him or herself for a service to be preformed by the healthcare provider, such as a medical procedure.

Smartcard 10 may be, for example, model AT88SC1616C, available from AMTEL Corporation of San Jose, Calif. This “CryptoMemory” card includes a 16 kbit EEPROM User Memory. Some of that memory may be permanently “locked”, e.g. made into WORM storage. More details of the smartcard are given in the AMTEL summary sheet REV. 2030ES-SMIC-04/03, available from AMTEL, the entire contents of which are hereby incorporated by reference. The smartcard memory may include data identifying the eligible individual. The identification data typically includes the name of the eligible individual, and biometric reference data, e.g. the so-called “minutiae” data representing a fingerprint, e.g. of the index finger or next available finger, of the eligible individual.

The data obtained from the smartcard may also include a Provider Identifier (PI) number, a unique memory means identifier, the name, date of birth, social security number or healthcare account number of the eligible individual. That information may also be transferred to the scanner for storage in the scanner memory.

The comparison between the finger print minutiae data read from the smartcard by terminal A and the fingerprint minutiae data obtained from scanning the service seeker by scanner B results in a determination as to the degree of similarity between the two. Based upon that, a decision is made as to whether the service seeker is the eligible individual. That decision is communicated to the healthcare provider who will then render the healthcare services, if the identity of the service seeker is confirmed to be the eligible individual.

The decision making process may generating an audit flag associated with one or more of the stored identifying indicia, the stored biometric data, and/or the candidate biometric data. That audit flag signifying that the appropriate match has not been found. After the services are rendered, the patient may “check out” by again presenting the smartcard for scanning. At that point, the staff of the healthcare provider may enter information relating to the services performed through the keyboard.

Periodically, for example, at the end of each day, the data files for all individuals for whom healthcare services have been provided during that period may be accumulated and transferred to associated equipment, for example, a host server. That information may also include the results of the decision as to whether the service seeker is the eligible individual.

The host server will store the transferred information to create medical files. Those medical files may be used by the host server to create information for transmission to the various reimbursing agencies for processing, often via the Inernet.

While only a single preferred embodiment of the present invention has been disclosed herein for purposes of illustration, it is obvious that many modifications and variations could be made thereto. It is intended to cover all of those modifications and variations which fall within the scope of the present invention, as defined by the following claims.

What is claimed is:

1. A method of using an integrated intelligent finger scanner for reducing fraud in a healthcare program intended to exclusively benefit eligible individuals, the intelligent integrated finger scanner including a finger scanner for acquiring the image of a finger, and data processing means for encoding the acquired image into biometric candidate data and for comparing the biometric candidate data with other data, the method comprising the steps of: (a) receiving, from a service seeker, memory means containing stored information comprising biometric reference data of an eligible individual; (b) reading, with a POS terminal having a memory means reader, the stored biometric reference data of the eligible individual from the memory means; (c) transmitting the read biometric reference data from the POS terminal to the integrated intelligent finger scanner operably connected to the POS terminal; (d) scanning, with the integrated intelligent finger scanner, a finger of the service seeker, so as to produce finger scan data; (e) processing the produced finger scan data to create biometric candidate data; (f) comparing the read biometric reference data with the created biometric candidate data; (g) ascertaining the degree of correspondence between the read biometric reference data and the created biometric candidate data; and (h) deciding whether the service seeker is the eligible individual based upon the degree of correspondence between the read biometric reference data and the created biometric candidate data.

2. The method of claim 1 wherein stored information further comprises identifying indicia.

3. The method of claim 2 wherein the step of reading includes the step of reading identifying indicia from the memory means, wherein the identifying indicia comprises at least one item from the following: name, social security number, healthcare account number, unique identifying number for memory means, primary care network (PCN), date of birth, sex.

4. The method of claim 1 wherein the stored information reference data includes fingerprint minutiae.

5. The method of claim 1 wherein the created biometric candidate data includes fingerprint minutiae.

6. The method of claim 1 wherein the memory means is a smartcard.

7. The method of claim 6 wherein the step of reading includes the step of reading the smartcard with a smartcard reader.

8. The method of claim 1 wherein the memory means includes an RFID tag.

9. The method of claim 8 wherein the step of reading includes the step of reading the RFID tag with a RFID tag reader.

10. The method of claim 1, wherein the step of deciding whether the service seeker is an eligible individual further includes the step of generating an audit flag associated with one or more of the identifying indicia, the stored biometric data, and/or the candidate biometric data.

11. The method of claim 1 further comprising the step of entering data into the POS terminal using data entry means.

12. The method of claim 1 further comprising the step of forwarding, from the POS terminal to a host server, data including at least one of the Provider Identifier (PI) number, the POS terminal identifier, a unique memory means identifier, information relating to type of transaction and/or the result of decision as to whether the service seeker is an eligible individual.

13. The method of the claim 1 further comprising the step of storing data selected including one or more of a Provider Identifier (PI) number, a POS terminal identifier, a unique memory means identifier, information relating to the type of transaction, the result of decision as to whether the service seeker is an eligible individual, name, social security number, healthcare account number, a unique identifying number for memory means, primary care network (PCN), date of birth, sex.
